(19) United States
(12) Patent Application Publication
(10) Pub. No.: US 2021/0333606 A1
(43) Pub. Date: Oct. 28, 2021

(54) DISPLAY DEVICE AND FABRICATING METHOD THEREOF

(71) Applicant: WUHAN CHINA STAR OPTOELECTRONICS TECHNOLOGY CO., LTD., Wuhan, Hubei (CN)

(72) Inventor: Yingbo ZHENG, Wuhan, Hubei (CN)

(21) Appl. No.: 16/626,525

(22) PCT Filed: Sep. 23, 2019
(86) PCT No.: PCT/CN2019/107239

§ 371 Date: Dec. 25, 2019

(30) Foreign Application Priority Data
Jun. 24, 2019 (CN) 201910551570.2

(51) Int. Cl. G02F 1/1345; G02F 1/1335

(52) U.S. Cl. CPC G02F 1/13452; G02F 1/133516

(57) ABSTRACT

The present invention provides a display device and a fabricating method thereof, the display device includes: an array substrate; a color filter substrate disposed on a surface of one side of the array substrate; and a flexible printed circuit bonded to a surface of one side of the array substrate away from the color filter substrate. The method for fabricating the display device includes: a step of providing an array substrate, a step of disposing a color filter substrate, and a step of bonding a flexible printed circuit. The technical effect of the present invention is that border width of the display device is reduced, and screen-to-body ratio of the display device is improved.

### FIELD OF INVENTION

This invention relates to the field of display technologies, and in particular, to a display device and a fabricating method thereof.

### BACKGROUND OF INVENTION

With increasing demand for mobile phones, full screens have emerged. Current mobile phones still cannot have a 100% full screen, but the screen-to-body ratio of mobile phones has been gradually improved. On the original basis, the border design of the liquid crystal display is optimized, and the width of the border of the display device is further reduced. How to further reduce the width of the border of the display device and further increase the screen-to-body ratio of the display device has become the focus of current research.

There are two main structural solutions for the border of the current display panels: the chip on glass (COG) solution and the chip on film (COF) solution. As shown in FIG. 1, in the COG solution, an integrated circuit unit 400 is bonded to an upper surface of an array substrate 100, and then a flexible printed circuit 300 is bonded on an outer side of the integrated circuit unit 400. The COG solution has lower cost and better yield, but its disadvantage is that the width of the border of the display device is large, and the screen-to-body ratio of the display device is relatively low.

As shown in FIG. 2, in the COF solution, an integrated circuit unit 400 is bonded to a flexible printed circuit 300, and no additional space is reserved on the upper surface of the array substrate 100, thereby reducing the width of the display device, but the cost is relatively high, and the yield of the display device is lower than that of the COG solution.

### Technical Problems

An object of the present invention is to solve the technical problem that the width of the border of the display device is large and the screen-to-body ratio of the display device is low in the prior art.

### Technical Solution

In order to achieve the above object, the present invention provides a display device including an array substrate; a color filter substrate disposed on a surface of one side of the array substrate; and a flexible printed circuit bonded to a surface of another side of the array substrate away from the color filter substrate.

Further, the display device includes: a backlight module disposed on a surface of the side of the array substrate away from the color filter substrate; wherein one end of the flexible printed circuit is bonded to a surface of the side of the array substrate away from the color filter substrate, and another end of the flexible printed circuit is bent, so that the backlight module is disposed between both ends of the flexible printed circuit.

Further, the display device includes a conductive extension layer electrically connected to the array substrate; wherein the conductive extension layer includes an integrated part including a first conductive portion disposed on a lateral surface of the array substrate; and a second conductive portion disposed on a surface of the side of the array substrate away from the color filter substrate; wherein the flexible printed circuit is bonded to a surface of one side of the second conductive portion away from the array substrate.

Further, the flexible printed circuit includes: a first flat portion bonded on a surface of the side of the second conductive portion away from the array substrate; a second flat portion disposed opposite to the first flat portion and parallel to the first flat portion; a bending portion having one end connected to the first flat portion and another end connected to the second flat portion; and an integrated circuit unit disposed on a surface of one side of the second flat portion adjacent to the first flat portion.

Further, the flexible printed circuit includes: a first flat portion bonded on a surface of the side of the second conductive portion away from the array substrate; a second flat portion disposed opposite to the first flat portion and parallel to the first flat portion; and a bending portion having one end connected to the first flat portion and another end connected to the second flat portion.

Further, the display device includes an integrated circuit unit disposed on a surface of one side of the array substrate away from the first flat portion and disposed opposite to the first flat portion.

In order to achieve the above object, the present invention further provides a method for fabricating the display device, including: a step of providing an array substrate, an array substrate is provided; a step of disposing a color filter substrate, a color filter substrate is disposed on an upper surface of the array substrate; a step of bonding a flexible printed circuit, a flexible printed circuit is bonded to a bottom surface of the array substrate.

Further, after the step of bonding the flexible printed circuit, the method for fabricating the display device includes a step of installing a backlight module, a backlight module is installed on a lower surface of the array substrate.

Further, after the step of disposing the color filter substrate, the method for fabricating the display device includes a step of forming a conductive extension layer, a conductive extension layer is formed on a lateral surface and a bottom surface of the array substrate.

Further, after the step of forming the conductive extension layer, the method for fabricating the display device includes a step of etching, the conductive extension layer is etched to form at least two wirings.

### BENEFICIAL EFFECT

The technical effect of the present embodiment is that a conductive extension layer is disposed on the lateral surface and the bottom surface of the array substrate, and the conductive extension layer is electrically connected to the wirings on the array substrate, so the conductive extension layer has a good electrical conductivity, and the flexible printed circuit is bonded to the bottom surface of the conductive extension layer, so that the electrical signal transmission between the flexible printed circuit and the array substrate is realized. Compared with the conventional display device, in the present invention the flexible printed circuit is bonded to the back surface of the conductive extension layer, that eliminates the need to occupy the border area of the display device, greatly reduces border width of the display device, and improves screen-to-body ratio of the display device.

### DESCRIPTION OF DRAWINGS

In order to more clearly illustrate the technical solutions in the embodiments of the present invention, the drawings to be used in the embodiments will be briefly described below. It is obvious that the drawings in the following description are merely some of the embodiments of the present invention, and other drawings may be obtained based on these figures by those skilled in the art without any creative work.

FIG. 1 is a schematic structural view of a display device in the prior art.

FIG. 2 is a schematic structural view of another display device in the prior art.

FIG. 3 is a flowchart of a method for preparing a display device according to an embodiment of the present invention.

FIG. 4 is a schematic structural view of a display device according to embodiment 1 of the present invention.

FIG. 5 is another schematic structural view of a display device according to embodiment 2 of the present invention.

Reference numbers and related parts in the drawings:
100, array substrate; 200, color filter substrate; 300, flexible printed circuit; 400, integrated circuit unit; 500, backlight module;
1, array substrate; 2, color filter substrate; 3, conductive extension layer; 4, flexible printed circuit; 5, integrated circuit unit; 6, backlight module;
31, first conductive portion; 32, second conductive portion;
41, first flat portion; 42, second flat portion; 43, bending portion.

### EMBODIMENTS OF THIS INVENTION

Preferred embodiments of the present invention with reference to the accompanying drawings are described below to illustrate that the invention can be practiced. These embodiments can fully introduce the technical content of the present invention to those skilled in the art, so that the technical content of the present invention is clearer and easier to be understood. However, the invention may be embodied in many different forms of embodiments, the scope of the invention is not limited to the embodiments mentioned herein, and the following description of the embodiments is not intended to limit the scope of the invention.

The directional terms mentioned in the present invention, such as up, down, front, back, left, right, inside, outside, side, etc., are only directions in the drawings, the directional terms used herein are used to explain and explain this invention, and they are not intended to limit the scope of the invention.

In the drawings, the components having similar structures are denoted by the same numerals. The structures and the components having similar function are denoted by similar numerals. In addition, to facilitate understanding and description, thickness and size of each of the components of the drawings are randomly shown, and the present disclosure does not limit thickness and size of each of the components.

When a first component is described as “on” a second component, the first component can be placed directly on the second component; there can also be an intermediate component, the first component is placed on the intermediate component, and the intermediate component is placed on the second component. When the first component is described as “installed on the second component” or “connected to the second component”, it should be understood as that the first component is directly installed on the second component or the first component is directly connected to the second component, or it should be understood as that the first component is indirectly installed on the second component via the intermediate component or the first component is indirectly connected to the second component via the intermediate component.

### Embodiment 1

As shown in FIG. 3, the present invention provides a method for fabricating a display device, including steps S1 to S6.

S1: a step of providing an array substrate. An array substrate, having a thickness ranging from 0.1 mm to 0.2 mm, is provided. In the present embodiment, 0.15 mm is preferred, and the array substrate provides circuit support for the display device.

The step of providing an array substrate includes a step of reserving mark points, and the mark points are reserved on an upper surface and a lower surface of the array substrate to provide alignment holes for the bonding of the flexible printed circuit to ensure accurate alignment of the flexible printed circuit. Compared with the method for fabricating a display device in the prior art, in this embodiment, since the flexible printed circuit needs to be bonded on a back surface of the array substrate, the mark points on the back surface of the array substrate are added to ensure the accurate alignment of the flexible printed circuit.

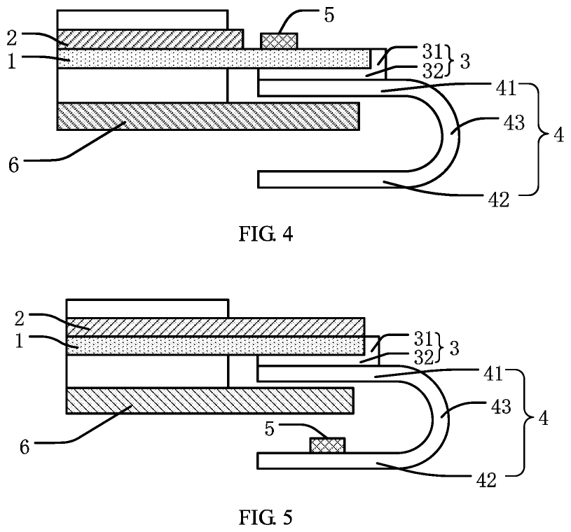

S2: a step of disposing a color filter substrate. A color filter substrate is disposed on the upper surface of the array substrate, and the color filter substrate is disposed on the upper surface of the array substrate through a glue layer, wherein the color filter substrate has a thickness ranging from 0.1 mm to 0.2 mm, in the present embodiment, 0.15 mm is preferred. As shown in FIG. 4, the length of the color filter substrate is smaller than the length of the array substrate, which provides space for the subsequent arrangement of the integrated circuit unit. The color filter substrate is used for filtering, so that the display device can display in color.

S3: a step of forming a conductive extension layer. A conductive extension layer is formed on a lateral surface and a bottom surface of the array substrate, the conductive extension layer includes an integrated part including a first conductive portion and a second conductive portion, the first conductive portion is disposed on the lateral surface of the array substrate, and the second conductive portion is disposed on the bottom surface of the array substrate and connected to the first conductive portion. The conductive extension layer is electrically connected to the array substrate to implement circuit conduction between the array substrate and a subsequent flexible printed circuit.

The conductive extension layer can be prepared by various options including inkjet printing technology, magnetron sputtering technology, evaporation technology, electroplating technology, 3D pad printing technology and the like.

A conductive silver paste or other conductive paste, such as an anisotropic conductive film (ACF), is sprayed on the lateral and bottom surfaces of the array substrate by using an inkjet printing technique, the conductive silver paste and the conductive paste itself having good electrical conductivity enables electrical conduction between the array substrate and subsequent flexible printed circuits.

Metal particles are sputtered on the lateral and bottom surfaces of the array substrate by magnetron sputtering. Compared with the conventional sputtering process, in this embodiment, the deceleration temperature needs to be controlled below 90° C. to avoid damage to the array substrate and the color filter substrate. The magnetron sputtered metal particles generally move in a one-dimensional direction. However, in this embodiment, metal particles need to be sputtered on the lateral and bottom surfaces of the array substrate, so the load platform used for sputtering needs a function to change direction, that is, the function of 3D sputtering, which ensures that the lateral surface and the bottom surface of the array substrate are sputtered with metal particles.

The vapor deposition technology has the characteristics such as low temperature and omnidirectionality compared with the magnetron sputtering technology. Therefore, it is necessary to wrap the array substrate and the light incident surface or the light exit surface of the color filter substrate with a protective film to prevent plating layer from interfering with the display effect of the display device.

A metal conductive layer is deposited on the lateral and bottom surfaces of the array substrate by vapor deposition or solution plating deposition techniques, and then the excess metal layer is fired by a laser to form a conductive extension layer.

Using 3D pad printing technique, a thin film conductive layer is transferred to the lateral surface and the bottom surface of the array substrate by 3D pad printing to form a conductive extension layer.

S4: a step of etching. The conductive extension layer is etched by laser to form at least two wirings. The wirings do not intersect each other, the conductive extension layer is prevented from short-circuiting and leakage, and the wirings are electrically connected to the array substrate and the flexible printed circuit to realize electrical connection between the array substrate and the flexible printed circuit.

S5: a step of bonding a flexible printed circuit. A flexible printed circuit (FPC) is bonded to a lower surface of the second conductive portion of the conductive extension layer, such that the flexible printed circuit electrically connect to the array substrate through the conductive extension layer.

The step of bonding a flexible printed circuit includes a step of bending and a step of bonding an integrated circuit unit. In the step of bending, one end of the flexible printed circuit is bonded to the second conductive portion of the conductive extension layer. The flexible printed circuit is bent such that another end of the flexible printed circuit is disposed at the back surface of the array substrate. The flexible printed circuit forms a first flat portion and a second flat portion that are oppositely disposed and parallel to each other, and a bending portion. The first flat portion is bonded to a lower surface of the second conductive portion of the conductive extension layer, the second flat portion is disposed on a back surface of the array substrate, one end of the bending portion is connected to the first flat portion, and another end is connected to the second flat portion. In the step of bonding an integrated circuit unit, in the embodiment, an integrated circuit unit is bonded on the upper surface of the array substrate such that the integrated circuit unit is disposed opposite to the first flat portion. Thereby the integrated circuit unit, the array substrate, and the flexible printed circuit forming a complete circuit conduction.

S6: a step of installing a backlight module. A backlight module is installed on a lower surface of the array substrate. One end of the backlight module is disposed between the first flat portion and the second flat portion of the flexible printed circuit, that is, opposite to the bending portion, and the backlight module provides a light source to the display device.

Before the step of disposing the color filter substrate, the method for fabricating the display device further includes a step of coating a sealant. A sealant is coated at an edge of the array substrate, wherein the sealant prevents external moisture from entering the display device.

After the step of disposing the color filter substrate, the method for fabricating the display device further includes a step of polishing, a step of chamfering, and a step of forming a protective layer, which are not described herein.

The technical effect of the method for fabricating the display device of the present embodiment is that a conductive extension layer is disposed on the lateral surface and the bottom surface of the array substrate, and the conductive extension layer is electrically connected to the wirings on the array substrate, so the conductive extension layer has a good electrical conductivity, and the flexible printed circuit is bonded to the bottom surface of the conductive extension layer, so that the electrical signal transmission between the flexible printed circuit and the array substrate is realized.

Compared with the conventional display device, the embodiment does not need to bond the flexible printed circuit on the outer side of the integrated circuit unit. The flexible printed circuit is bonded to the back surface of the conductive extension layer, and the flexible printed circuit is opposite to the integrated circuit unit. The embodiment eliminates the need to occupy the border area of the display device, greatly reduces border width of the display device, and improves screen-to-body ratio of the display device.

The embodiment further provides a display device prepared by the abovementioned method for fabricating the display device. As shown in FIG. 4, the display device includes an array substrate 1, a color filter substrate 2, a conductive extension layer 3, a flexible printed circuit 4, an integrated circuit unit 5 and a backlight module 6.

The array substrate 1 has a thickness ranging from 0.1 mm to 0.2 mm. In the present embodiment, 0.15 mm is preferred, and the array substrate 1 provides circuit support for the display device.

The color filter substrate 2 is disposed on the upper surface of the array substrate 1, and the color filter substrate 2 has a thickness ranging from 0.1 mm to 0.2 mm, in the present embodiment, 0.15 mm is preferred. The length of the color filter substrate 2 is smaller than the length of the array substrate 1, which provides space for the subsequent arrangement of the integrated circuit unit. The color filter substrate 2 is used for filtering, so that the display device can display in color.

The conductive extension layer 3 is electrically connected to the array substrate 1 and disposed on a lateral surface and a bottom surface of the array substrate 1, and the conductive extension layer 3 is used to connect the array substrate 1 and the flexible printed circuit 4, so that the electrical signal transmission between the array substrate 1 and the flexible printed circuit 4 is realized. The conductive extension layer 3 includes an integrated part including a first conductive portion 31 and a second conductive portion 32, the first conductive portion 31 is disposed on the lateral surface of the array substrate 1, and the second conductive portion 32 is disposed on the bottom surface of the array substrate 1 and connected to the first conductive portion 31. The conductive extension layer 3 includes at least two wirings, the wirings do not intersect each other, so the conductive extension layer 3 is prevented from short-circuiting and leakage,

The flexible printed circuit 4 is bonded to a lower surface of the second conductive portion 32 of the conductive extension layer 3, such that the flexible printed circuit 4 electrically connect to the array substrate 1 through the conductive extension layer 3. The flexible printed circuit 4 includes a first flat portion 41 and a second flat portion 42 that are oppositely disposed and parallel to each other, and a bending portion 43. The first flat portion 41 is bonded to a lower surface of the second conductive portion 32 of the conductive extension layer 3, the second flat portion 42 is disposed on a back surface of the array substrate 1, one end of the bending portion 43 is connected to the first flat portion 41, and another end is connected to the second flat portion 42.

The integrated circuit unit 5 is bonded on the upper surface of the array substrate 1, such that the integrated circuit unit 5 is disposed opposite to the first flat portion 41 of the flexible printed circuit 4. Thereby the integrated circuit unit 5, the array substrate 1, and the flexible printed circuit 4 forming a complete circuit conduction.

The embodiment does not need to bond the flexible printed circuit 4 on the outer side of the integrated circuit unit 5. The flexible printed circuit 4 is bonded to the back surface of the conductive extension layer 3, and the flexible printed circuit 4 is opposite to the integrated circuit unit 5. The embodiment eliminates the need to occupy the border area of the display device, greatly reduces border width of the display device, and improves screen-to-body ratio of the display device.

A backlight module 6 is installed on a back surface of the array substrate 1. One end of the backlight module 6 is disposed between the first flat portion 41 and the second flat portion 42 of the flexible printed circuit 4, that is, opposite to the bending portion 43, and the backlight module 6 provides a light source to the display device.

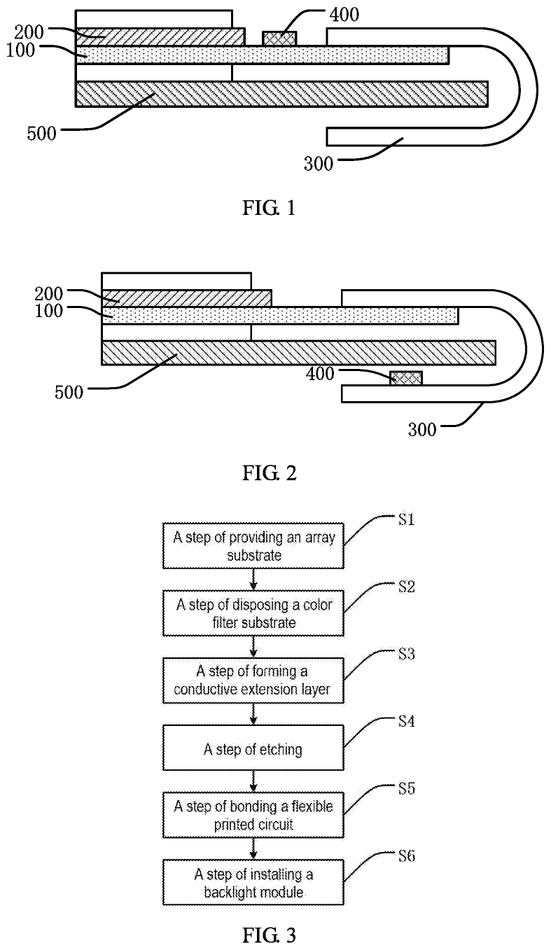

As shown in FIG. 1, in the display device in the prior art, the flexible printed circuit 300 is bonded to the upper surface of the array substrate 100, so that a bonding region of the flexible printed circuit 300 needs to be reserved at the edge of the array substrate 100. The width of the bonding area is 0.4 mm˜0.5 mm, and the bonding area occupies the border area of the display device. The width of the border of the conventional display device is 2 mm˜3 mm, which increases the width of the border of the display device to a certain extent and reduces the screen-to-body ratio. The display device in the embodiment does not need to reserve the bonding area, and the width for bonding on the back surface of the array substrate is 0˜0.1 mm, and the width of the border of the display device is 1 mm˜2 mm, which greatly reduces the width of the border of the display device and improves the screen-to-body ratio of the display device.

The technical effect of the display device in the embodiment is that a conductive extension layer is disposed on the lateral surface and the bottom surface of the array substrate, and the conductive extension layer is electrically connected to the wirings on the array substrate, so the conductive extension layer has a good electrical conductivity, and the flexible printed circuit is bonded to the bottom surface of the conductive extension layer, so that the electrical signal transmission between the flexible printed circuit and the array substrate is realized.

Compared with the conventional display device, the embodiment does not need to bond the flexible printed circuit on the outer side of the integrated circuit unit. The flexible printed circuit is bonded to the back surface of the conductive extension layer, and the flexible printed circuit is opposite to the integrated circuit unit. The embodiment eliminates the need to occupy the border area of the display device, greatly reduces border width of the display device, and improves screen-to-body ratio of the display device.

### Embodiment 2

As shown in FIG. 3, the present invention provides a method for fabricating a display device, including steps S1 to S6.

S1: a step of providing an array substrate. An array substrate, having a thickness ranging from 0.1 mm to 0.2 mm, is provided. In the present embodiment, 0.15 mm is preferred, and the array substrate provides circuit support for the display device.

The step of providing an array substrate includes a step of reserving mark points, and the mark points are reserved on an upper surface and a lower surface of the array substrate to provide alignment holes for the bonding of the flexible printed circuit to ensure accurate alignment of the flexible printed circuit. Compared with the method for fabricating a display device in the prior art, in this embodiment, since the flexible printed circuit needs to be bonded on a back surface of the array substrate, the mark points on the back surface of the array substrate are added to ensure the accurate alignment of the flexible printed circuit.

S2: a step of disposing a color filter substrate. A color filter substrate is disposed on the upper surface of the array substrate, and the color filter substrate is disposed on the upper surface of the array substrate through a glue layer, wherein the color filter substrate has a thickness ranging from 0.1 mm to 0.2 mm, in the present embodiment, 0.15 mm is preferred. As shown in FIG. 5, the length of the color filter substrate is equal to the length of the array substrate. At present, the space of the integrated circuit unit is not required to be reserved, the width of the non-display area of the display device is reduced to a certain extent, and the screen-to-body ratio of the display device is improved. The color filter substrate is used for filtering, so that the display device can display in color.

S3: a step of forming a conductive extension layer. A conductive extension layer is formed on a lateral surface and a bottom surface of the array substrate, the conductive extension layer includes an integrated part including a first conductive portion and a second conductive portion, the first conductive portion is disposed on the lateral surface of the array substrate, and the second conductive portion is disposed on the bottom surface of the array substrate and connected to the first conductive portion. The conductive extension layer is electrically connected to the array substrate to implement circuit conduction between the array substrate and a subsequent flexible printed circuit.

The conductive extension layer can be prepared by various options including inkjet printing technology, magnetron sputtering technology, evaporation technology, electroplating technology, 3D pad printing technology and the like.

A conductive silver paste or other conductive paste, such as an anisotropic conductive film (ACF), is sprayed on the lateral and bottom surfaces of the array substrate by using an inkjet printing technique, the conductive silver paste and the conductive paste itself having good electrical conductivity enables electrical conduction between the array substrate and subsequent flexible printed circuits.

Metal particles are sputtered on the lateral and bottom surfaces of the array substrate by magnetron sputtering. Compared with the conventional sputtering process, in this embodiment, the deceleration temperature needs to be controlled below 90° C. to avoid damage to the array substrate and the color filter substrate. The magnetron sputtered metal particles generally move in a one-dimensional direction. However, in this embodiment, metal particles need to be sputtered on the lateral and bottom surfaces of the array substrate, so the load platform used for sputtering needs a function to change direction, that is, the function of 3D sputtering, which ensures that the lateral surface and the bottom surface of the array substrate are sputtered with metal particles.

The vapor deposition technology has the characteristics such as low temperature and omnidirectionality compared with the magnetron sputtering technology. Therefore, it is necessary to wrap the array substrate and the light incident surface or the light exit surface of the color filter substrate with a protective film to prevent plating layer from interfering with the display effect of the display device.

A metal conductive layer is deposited on the lateral and bottom surfaces of the array substrate by vapor deposition or solution plating deposition techniques, and then the excess metal layer is fired by a laser to form a conductive extension layer.

Using 3D pad printing technique, a thin film conductive layer is transferred to the lateral surface and the bottom surface of the array substrate by 3D pad printing to form a conductive extension layer.

S4: a step of etching. The conductive extension layer is etched by laser to form at least two wirings. The wirings do not intersect each other, the conductive extension layer is prevented from short-circuiting and leakage, and the wirings are electrically connected to the array substrate and the flexible printed circuit to realize electrical connection between the array substrate and the flexible printed circuit.

S5: a step of bonding a flexible printed circuit. A flexible printed circuit (FPC) is bonded to a lower surface of the second conductive portion of the conductive extension layer, such that the flexible printed circuit electrically connect to the array substrate through the conductive extension layer.

The step of bonding a flexible printed circuit includes a step of bending and a step of bonding an integrated circuit unit. In the step of bending, one end of the flexible printed circuit is bonded to the second conductive portion of the conductive extension layer. The flexible printed circuit is bent such that another end of the flexible printed circuit is disposed at the back surface of the array substrate. The flexible printed circuit forms a first flat portion and a second flat portion that are oppositely disposed and parallel to each other, and a bending portion. The first flat portion is bonded to a lower surface of the second conductive portion of the conductive extension layer, the second flat portion is disposed on a back surface of the array substrate, one end of the bending portion is connected to the first flat portion, and another end is connected to the second flat portion. In the step of bonding an integrated circuit unit, in the embodiment, an integrated circuit unit is bonded on the upper surface of the second flat portion of the flexible printed circuit such that the integrated circuit unit, the array substrate, and the flexible printed circuit form a complete circuit conduction. Compared with embodiment 1, the integrated circuit unit of the embodiment does not occupy the bonding space of the array substrate, which reduces the width of the border of the display device to a certain extent and improves the screen-to-body ratio of the display device.

S6: a step of installing a backlight module. A backlight module is installed on a lower surface of the array substrate. One end of the backlight module is disposed between the first flat portion and the second flat portion of the flexible printed circuit, that is, opposite to the bending portion, and the backlight module provides a light source to the display device.

Before the step of disposing the color filter substrate, the method for fabricating the display device further includes a step of coating a sealant. A sealant is coated at an edge of the array substrate, wherein the sealant prevents external moisture from entering the display device.

After the step of disposing the color filter substrate, the method for fabricating the display device further includes a step of polishing, a step of chamfering, and a step of forming a protective layer, which are not described herein.

The technical effect of the method for fabricating the display device of the present embodiment is that a conductive extension layer is disposed on the lateral surface and the bottom surface of the array substrate, and the conductive extension layer is electrically connected to the wirings on the array substrate, so the conductive extension layer has a good electrical conductivity, and the flexible printed circuit is bonded to the bottom surface of the conductive extension layer, so that the electrical signal transmission between the flexible printed circuit and the array substrate is realized.

Compared with the conventional display device, in the embodiment the flexible printed circuit is bonded to the back surface of the conductive extension layer, that eliminates the need to occupy the border area of the display device, greatly reduces border width of the display device, and improves screen-to-body ratio of the display device.

The embodiment further provides a display device prepared by the abovementioned method for fabricating the display device. As shown in FIG. 5, the display device includes an array substrate 1, a color filter substrate 2, a conductive extension layer 3, a flexible printed circuit 4, an integrated circuit unit 5 and a backlight module 6.

The array substrate 1 has a thickness ranging from 0.1 mm to 0.2 mm. In the present embodiment, 0.15 mm is preferred, and the array substrate 1 provides circuit support for the display device.

The color filter substrate 2 is disposed on the upper surface of the array substrate 1, and the color filter substrate 2 has a thickness ranging from 0.1 mm to 0.2 mm, in the present embodiment, 0.15 mm is preferred. The length of the color filter substrate 2 is equal to the length of the array substrate 1, and the space of the integrated circuit unit is not required to be reserved. Compared with embodiment 1, the width of the non-display area of the display device is reduced to a certain extent, and the screen-to-body ratio of the display device is improved. The color filter substrate 2 is used for filtering, so that the display device can display in color.

The conductive extension layer 3 is electrically connected to the array substrate 1 and disposed on a lateral surface and a bottom surface of the array substrate 1, and the conductive extension layer 3 is used to connect the array substrate 1 and the flexible printed circuit 4, so that the electrical signal transmission between the array substrate 1 and the flexible printed circuit 4 is realized. The conductive extension layer 3 includes an integrated part including a first conductive portion 31 and a second conductive portion 32, the first conductive portion 31 is disposed on the lateral surface of the array substrate 1, and the second conductive portion 32 is disposed on the bottom surface of the array substrate 1 and connected to the first conductive portion 31. The conductive extension layer 3 includes at least two wirings, the wirings do not intersect each other, so the conductive extension layer 3 is prevented from short-circuiting and leakage.

The flexible printed circuit 4 is bonded to a lower surface of the second conductive portion 32 of the conductive extension layer 3, such that the flexible printed circuit 4 electrically connect to the array substrate 1 through the conductive extension layer 3. The flexible printed circuit 4 includes a first flat portion 41 and a second flat portion 42 that are oppositely disposed and parallel to each other, and a bending portion 43. The first flat portion 41 is bonded to a lower surface of the second conductive portion 32 of the conductive extension layer 3, the second flat portion 42 is disposed on a back surface of the array substrate 1, one end of the bending portion 43 is connected to the first flat portion 41, and another end is connected to the second flat portion 42.

The integrated circuit unit 5 is bonded on the upper surface of the array substrate 1, such that the integrated circuit unit 5 is disposed opposite to the first flat portion 41 of the flexible printed circuit 4. Thereby the integrated circuit unit 5, the array substrate 1, and the flexible printed circuit 4 forming a complete circuit conduction.

In the embodiment, the flexible printed circuit 4 is bonded to the back surface of the conductive extension layer 3, and the embodiment eliminates the need to occupy the border area of the display device, greatly reduces border width of the display device, and improves screen-to-body ratio of the display device.

A backlight module 6 is installed on a back surface of the array substrate 1. One end of the backlight module 6 is disposed between the first flat portion 41 and the second flat portion 42 of the flexible printed circuit 4, that is, opposite to the bending portion 43, and the backlight module 6 provides a light source to the display device.

As shown in FIG. 2, in the display device in the prior art, the flexible printed circuit 300 is bonded to the upper surface of the array substrate 100, so that a bonding region of the flexible printed circuit 300 needs to be reserved at the edge of the array substrate 100. The width of the bonding area is 0.4 mm˜0.5 mm, and the bonding area occupies the border area of the display device. The width of the border of the conventional display device is 2 mm˜3 mm, which increases the width of the border of the display device to a certain extent and reduces the screen-to-body ratio. The display device in the embodiment does not need to reserve the bonding area, and the width for bonding on the back surface of the array substrate is 0˜0.1 mm, and the width of the border of the display device is 0.5 mm˜1 mm, which reduces the width of the border of the display device and improves the screen-to-body ratio of the display device.

The technical effect of the display device in the embodiment is that a conductive extension layer is disposed on the lateral surface and the bottom surface of the array substrate, and the conductive extension layer is electrically connected to the wirings on the array substrate, so the conductive extension layer has a good electrical conductivity, and the flexible printed circuit is bonded to the bottom surface of the conductive extension layer, so that the electrical signal transmission between the flexible printed circuit and the array substrate is realized.

Compared with the conventional display device, in the embodiment, the flexible printed circuit is bonded to the back surface of the conductive extension layer, and the embodiment eliminates the need to occupy the border area of the display device, greatly reduces border width of the display device, and improves screen-to-body ratio of the display device.

The above description is only a preferred embodiment of the present invention, and it should be noted that those skilled in the art can also make several improvements and modifications without departing from the principles of the present invention. These improvements and modifications should also be considered as the scope of the present invention.

What is claimed is:

1. A display device, comprising:
an array substrate;
a color filter substrate disposed on a surface of one side of the array substrate;
a flexible printed circuit bonded to a surface of another side of the array substrate away from the color filter substrate.

2. The display device as claimed in claim 1, comprising:
a backlight module disposed on a surface of the side of the array substrate away from the color filter substrate;
wherein one end of the flexible printed circuit is bonded to a surface of the side of the array substrate away from the color filter substrate, and another end of the flexible printed circuit is bent, so that the backlight module is disposed between both ends of the flexible printed circuit.

3. The display device as claimed in claim 1, comprising:
a conductive extension layer electrically connected to the array substrate;
wherein the conductive extension layer comprises an integrated part comprising:
a first conductive portion disposed on a lateral surface of the array substrate; and
a second conductive portion disposed on a surface of the side of the array substrate away from the color filter substrate;
wherein the flexible printed circuit is bonded to a surface of one side of the second conductive portion away from the array substrate.

4. The display device as claimed in claim 3, wherein
the flexible printed circuit comprises:
a first flat portion bonded on a surface of the side of the second conductive portion away from the array substrate;
a second flat portion disposed opposite to the first flat portion and parallel to the first flat portion;
a bending portion having one end connected to the first flat portion and another end connected to the second flat portion; and
an integrated circuit unit disposed on a surface of one side of the second flat portion adjacent to the first flat portion.

5. The display device as claimed in claim 3, wherein
the flexible printed circuit comprises:
a first flat portion bonded on a surface of the side of the second conductive portion away from the array substrate;
a second flat portion disposed opposite to the first flat portion and parallel to the first flat portion; and
a bending portion having one end connected to the first flat portion and another end connected to the second flat portion.

6. The display device as claimed in claim 5, comprising:
an integrated circuit unit disposed on a surface of one side of the array substrate away from the first flat portion and disposed opposite to the first flat portion.

7. A method for fabricating the display device, comprising:
a step of providing an array substrate, providing an array substrate;
a step of disposing a color filter substrate, and disposing a color filter substrate on an upper surface of the array substrate;
a step of bonding a flexible printed circuit, bonding a flexible printed circuit to a bottom surface of the array substrate.

8. The method for fabricating the display device as claimed in claim 7, wherein
after the step of bonding the flexible printed circuit, the method comprises:
a step of installing a backlight module, installing a backlight module on a lower surface of the array substrate.

9. The method for fabricating the display device as claimed in claim 7, wherein
after the step of disposing the color filter substrate, the method comprises:
a step of forming a conductive extension layer, forming a conductive extension layer on a lateral surface and a bottom surface of the array substrate.

10. The method for fabricating the display device as claimed in claim 9, wherein
after the step of forming the conductive extension layer, the method comprises:
a step of etching, etching the conductive extension layer to form at least two wirings.
